(19) United States
(12) Patent Application Publication
(10) Pub. No.: US 2023/0311752 A1
(43) Pub. Date: Oct. 5, 2023

(54) VEHICLE MANUFACTURING METHOD AND VEHICLE CONTROL SYSTEM

(71) Applicant: HONDA MOTOR CO., LTD., Tokyo (JP)

(72) Inventor: Yosuke Shionoya, Tokyo (JP)

(21) Appl. No.: 18/182,643

(22) Filed: Mar. 13, 2023

(30) Foreign Application Priority Data
Mar. 31, 2022 (JP) 2022-061005

(51) Int. Cl. B60Q 1/50; B62D 65/02

(52) U.S. Cl. CPC B60Q 1/544; B62D 65/02

(57) ABSTRACT

A vehicle manufacturing method includes a placement step of placing, in a vehicle, a vehicle control unit and a master control unit, the vehicle control unit including a non-volatile program storage unit and controlling a function unit installed in the vehicle by executing a program stored in the program storage unit, a wire-connection step of connecting the master control unit with plural vehicle control units by a communication wire, and a writing step of executing a writing process of writing the program to the program storage unit for the vehicle control unit which is connected with the master control unit by the communication wire.

### INCORPORATION BY REFERENCE

The present application claims priority under 35 U.S.C. § 119 to Japanese Patent Application No. 2022-061005 filed on Mar. 31, 2022. The content of the application is incorporated herein by reference in its entirety.

### BACKGROUND OF THE INVENTION

### Field of the Invention

The present invention relates to a vehicle manufacturing method and a vehicle control system.

### Description of the Related Art

In recent years, with sophistication of functions of vehicles, an increase in electronic control units (ECU) installed in a vehicle and sophistication of programs controlling ECUs have been progressing. For example, achievement in research and development about an improvement in fuel efficiently which contributes to higher energy efficiency has been applied to vehicles, and enhancement of functions of an ECU which controls an engine or a motor has been progressing. Further, installation of a sophisticated ECU which deals with driving assistance technologies and preventive safety technologies has been progressing. With such technological evolution, management of programs installed in an ECU has become an important problem. For example, Japanese Patent Laid-Open No. 2019-144669 discloses a method of updating an ECU which is installed in a vehicle.

### SUMMARY OF THE INVENTION

### Technical Problem

A program to be executed by an ECU is demanded to be compatible with a specification of a vehicle, and version upgrading of a program is performed with the aim of an improvement in a function and an improvement in reliability. Consequently, in a process of manufacturing a vehicle, necessity of checking a specification or a version of a program for an ECU occurs. For example, as for some ECUs, programs are written in those by a supplier manufacturing the ECUs, and the ECUs are thereafter supplied to manufacturing steps. For such ECUs, in the manufacturing steps of the vehicle, it is necessary to check compatibility between the programs and the specification of the vehicle and the versions of the programs, and the programs are updated in accordance with necessity. Consequently, there has been a problem that management of the programs of the ECUs in the manufacturing steps of the vehicle is time consuming. In view of reduction in an emission amount of carbon dioxide in manufacturing steps of the vehicle, it is desirable to shorten a time period for management of a program for an ECU and to improve manufacturing efficiency of the vehicle.

An object of the present invention, which has been made in consideration of such a background, is to shorten a work time period for management of a program for an ECU to be installed in a vehicle and to improve manufacturing efficiency of a vehicle.

### Solution to Problem

One aspect for achieving the above object provides a vehicle manufacturing method including: a placement step of placing, in a vehicle, a vehicle control unit and a master control unit, the vehicle control unit including a non-volatile program storage unit and controlling a function unit installed in the vehicle by executing a program stored in the program storage unit; a wire-connection step of connecting the master control unit with a plurality of the vehicle control units by a communication wire; and a writing step of executing a writing process of writing the program to the program storage unit for the vehicle control unit which is connected with the master control unit by the communication wire by the master control unit.

### Advantageous Effects of Invention

In the above method, it is possible to write a program to a vehicle control unit by a master control unit in manufacturing steps of a vehicle. Accordingly, a step of checking a specification or a state of the program of the vehicle control unit and a step of writing the program to each vehicle control unit can be skipped or simplified. Thus, it is possible to shorten a production time period in a manufacturing factory of the vehicle while an improvement in fuel efficiency of the vehicle and installation of driving assistance technologies and preventive safety technologies in the vehicle are handled, and reduction in an emission amount of carbon dioxide in the manufacturing steps of the vehicle can be realized.

### BRIEF DESCRIPTION OF DRAWINGS

FIG. 1 is an outline configuration diagram of a vehicle control system;

FIG. 2 is an explanatory diagram of manufacturing steps of a vehicle;

FIG. 3 is a block diagram illustrating a principal component configuration of the vehicle control system;

FIG. 4 is a flowchart illustrating actions of the vehicle control system;

FIG. 5 is a flowchart illustrating actions of the vehicle control system; and

FIG. 6 is a flowchart illustrating actions of the vehicle control system.

### DETAILED DESCRIPTION OF THE PREFERRED EMBODIMENT

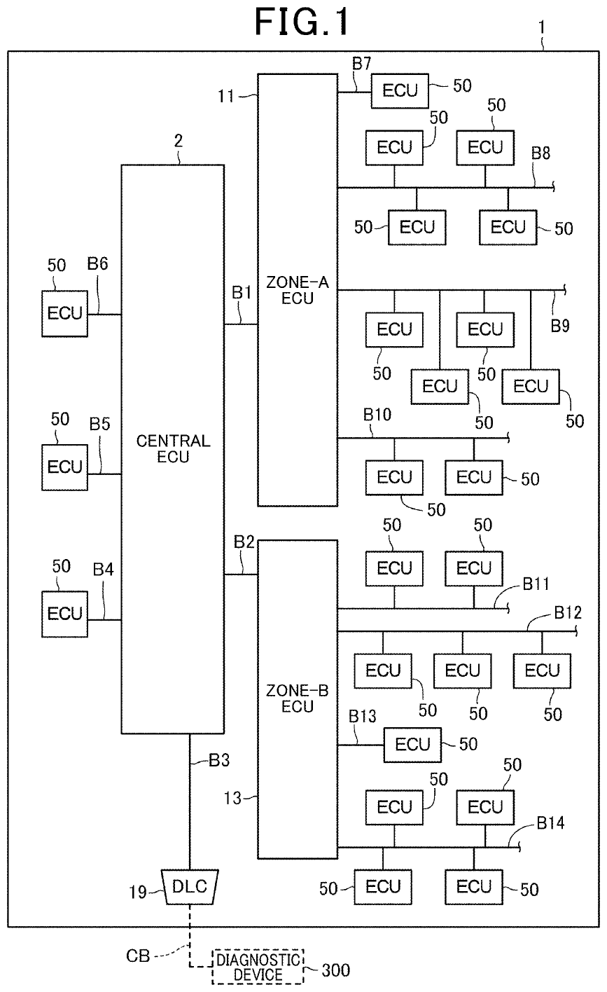

FIG. 1 is a diagram illustrating a vehicle control system 1.

The vehicle control system 1 is formed from plural ECUs 50 which control function units installed in a vehicle. The vehicle control system 1 controls the function units of the vehicle and thereby realizes travel of the vehicle and various functions.

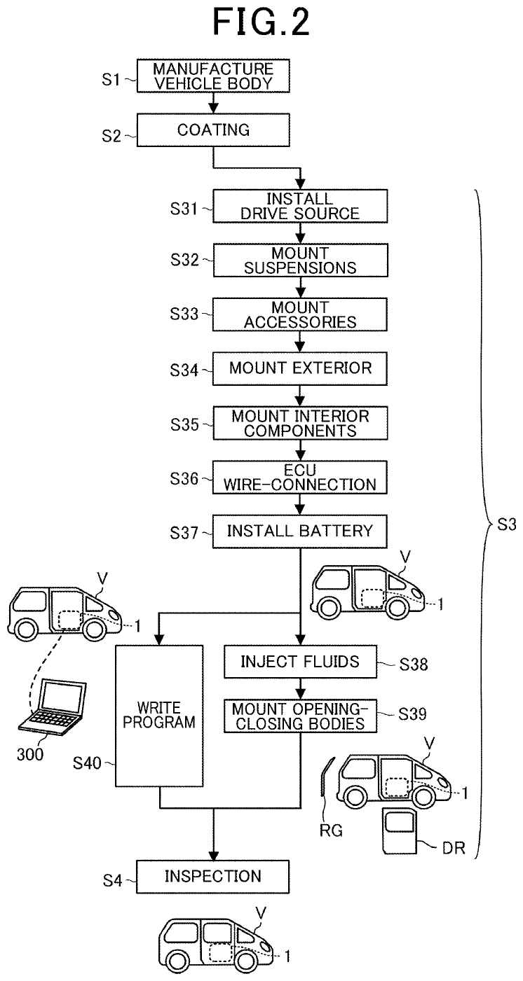

A specific form of the vehicle in which the vehicle control system 1 is installed is not limited. The vehicle may be a four-wheeled automobile or may be a motorcycle or another moving body. The vehicle may be a vehicle which uses an internal combustion engine as a drive source, may be an electric vehicle which uses a motor as a drive source, or may be a hybrid vehicle which uses an internal combustion engine and a motor. In the present embodiment, as illustrated in FIG. 2, a description will be made about a vehicle V, which is a four-wheeled automobile, as an example.

The following description explains examples of various ECUs 50 which are installed in the vehicle V and apparatuses which are controlled by the ECUs 50. It is not intended that the ECUs 50 included in the vehicle V as an application target of the present disclosure are limited to a manner of connection illustrated in FIG. 1.

The vehicle control system 1 includes a central ECU 2 which performs general control of the vehicle V and information processing. The central ECU 2 is connected with communication lines including communication wires B1 to B6. The central ECU 2 realizes a function of a gateway which manages delivery and acceptance of communication data among those communication lines. The central ECU 2 executes writing of programs to be executed by the ECUs for the ECUs which are connected with the central ECU 2 by the communication wires B1 to B6 and for the ECUs which are connected with the above ECUs by other communication wires B7 to B14. Writing of a program includes update of a program which is already written in the ECU and newly writing a program in the ECU. The central ECU 2 executes over-the-air (OTA) management, for example. The OTA management includes control about a process of downloading an update program for the ECU included in the vehicle V from a server on the outside of the vehicle and about a process of applying a downloaded update program to an in-vehicle device, for example. The central ECU 2 corresponds to one example of a master control unit in the present disclosure, and each of the ECUs to which a program is written by the central ECU 2 corresponds to one example of a vehicle control unit. The vehicle control unit includes a zone-A ECU 11, a zone-B ECU 13, and the ECUs 50 illustrated in FIG. 1, for example.

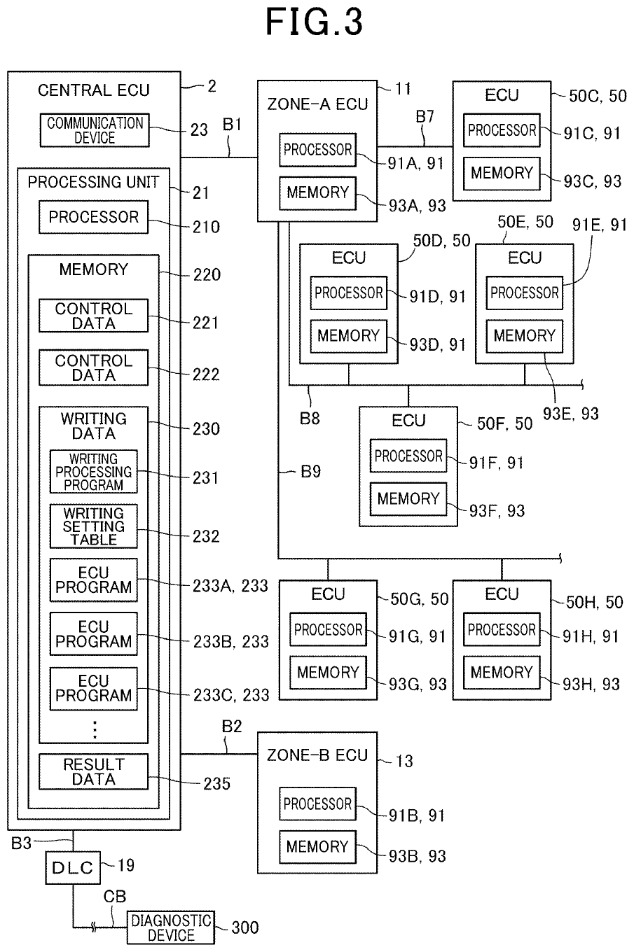

In FIG. 1 and FIG. 3 described later, each of various ECUs which are connected with the central ECU 2, the zone-A ECU 11, and the zone-B ECU 13 is denoted as ECU 50.

With the central ECU 2, the zone-A ECU 11 is connected by the communication wire B1, and the zone-B ECU 13 is connected by the communication wire B2. As described later, in addition, plural ECUs 50 are connected with the zone-A ECU 11 and the zone-B ECU 13. The zone-A ECU 11 manages delivery and acceptance of communication data between the central ECU 2 and the ECUs 50 which are connected with the zone-A ECU 11. The zone-B ECU 13 manages delivery and acceptance of communication data between the central ECU 2 and the ECUs 50 which are connected with the zone-B ECU 13.

With the central ECU 2, a data link connector (DLC) 19 is connected by the communication wire B3. The DLC 19 is an interface device which connects external devices of the vehicle V with the central ECU 2. The DLC 19 includes a connector with which a communication cable is connectable and is connected with a diagnostic device 300, for example, via the communication cable CB. The DLC 19 corresponds to one example of a connection unit in the present disclosure.

The diagnostic device 300 is a terminal device which has a processor, and which is used by a worker in manufacturing steps of the vehicle V. The diagnostic device 300 is connected with the DLC 19 by the communication cable CB, for example. The diagnostic device 300 performs transmission and reception of various commands and data to and from the vehicle control system 1, thereby acquires information about the vehicle control system 1, and transmits an instruction to the vehicle control system 1. The diagnostic device 300 includes operation units such as keys and switches which are operated by the worker, a display unit which displays an action state of the diagnostic device 300 and information about the vehicle control system 1, a connector for connecting with the communication cable CB, and so forth. The diagnostic device 300 corresponds to one example of an external device in the present disclosure.

With the central ECU 2, plural ECUs 50 are connected by the communication wires B4, B5, and B6. Those ECUs 50 include a vehicle-to-everything (V2X) communication device, for example. The V2X communication device is a communication device that includes a communication antenna and a communication circuit, which are not illustrated, and that has a wireless communication function and performs vehicle-to-vehicle communication or road-to-vehicle communication in accordance with control by the central ECU 2. The ECUs 50 which are connected with the central ECU 2 may include a telematics control unit (TCU). The TCU is a wireless communication device that includes a communication antenna and a communication circuit, which are not illustrated, and that executes wireless data communication by a cellular communication system such as long-term evolution (LTE) or the fifth-generation mobile communication system (5G). The ECUs 50 which are connected with the central ECU 2 may include an in-vehicle infotainment (IVI) ECU. With the IVI-ECU, in-vehicle apparatuses such as an automotive navigation system, various cameras including a rear camera, an audio player, a monitor, a touch panel, operation elements such as keys and switches, a speaker, and a microphone are connected. The IVI-ECU controls the in-vehicle apparatuses and thereby provides various kinds of information and entertainment for an occupant of the vehicle V. For example, the IVI-ECU executes control such as starts and stops of the in-vehicle apparatuses, control for outputting data and so forth, which are detected by a sensor by the other ECU, and so forth.

The ECUs 50 which are connected with the central ECU 2 may include a driving assistance ECU which executes control for automatically parking the vehicle V at a parking position or an assistance function in a case where a driver parks the vehicle V. Function units as control targets of the driving assistance ECU include various cameras, a monitor, a touch panel, a steering device, a brake mechanism, and an acceleration device, which are installed in the vehicle V, for example.

The DLC 19 is one example of a function unit which is controlled by the central ECU 2. The same applies to the V2X communication device and the TCU.

With the zone-A ECU 11, plural ECUs 50 are connected by the communication wires B7 to B10. The ECUs 50 which are connected with the zone-A ECU 11 include a fuel injection (FI) control unit, a motor control unit, a battery (BATT) control unit, a shift control unit, a vehicle stability assist (VSA) control unit, and so forth, for example. The ECUs 50 which are connected with the zone-A ECU 11 by the communication wires B7 to B10 can be considered to be function units as control targets of the zone-A ECU 11.

The FI control unit controls a fuel injection amount and a fuel injection timing in an internal combustion engine which is installed in the vehicle V. Function units as control targets of the FI control unit include an electronic control fuel injection device and may include sensors. As sensors, an 02 sensor, a knock sensor, a cam angle sensor, a crank angle sensor, an intake air temperature sensor, an exhaust gas temperature sensor, and so forth can be raised. The motor control unit controls a rotation speed of a motor which is installed in the vehicle V. Function units as control targets of the motor control unit include an inverter circuit which supplies a driving current to the motor and may include various sensors. The BATT control unit performs charge control, discharge control, and management of a remaining charge amount for a traveling battery which is installed in the vehicle V. A battery as a function unit as a control target of the BATT control unit is a battery that is separately provided from a starting battery which supplies power to each unit of the vehicle control system 1 and is installed in the vehicle V for supplying a driving power source for the motor. The traveling battery may be a lithium-ion secondary battery, a lithium polymer battery, a nickel-metal hydride battery, a solid-state battery, another secondary battery, or a capacitor. Function units as control targets of the BATT control unit may include a regenerative mechanism which generates regenerative power by traveling energy of the vehicle V. Meanwhile, the starting battery of the vehicle V is a secondary battery which supplies power to each unit of the vehicle control system 1 in a state where a power source of the vehicle V is turned off and is charged by a generating device installed in the vehicle V during travel of the vehicle V. For example, the starting battery is formed from a lead-acid battery, another secondary battery, or a capacitor.

The shift control unit controls a shift mechanism of the vehicle V in accordance with a traveling state of the vehicle V and an operation by the driver. Function units as control targets of the shift control unit include the shift mechanism of the vehicle V, and specifically, a step automatic transmission (AT), a continuously variable transmission (CVT), a dual clutch transmission (DCT), or the like is raised. The function units as the control targets of the shift control unit may include a shift position sensor, a shift switch, a shift lever, and so forth.

A function unit as a control target of the VSA control unit is an actuator provided to a brake mechanism of the vehicle V, for example. The VSA control unit causes the actuator of the brake mechanism to act in accordance with a posture or the like of the vehicle V and thereby stabilizes the posture of the traveling vehicle V, and in advance prevents a slip and a spin, for example.

With the zone-B ECU 13, plural ECUs 50 are connected by the communication wires B11 to B14. The ECUs 50 which are connected with the zone-B ECU 13 includes a light control unit and an entry control unit, for example. The ECUs 50 which are connected with the zone-B ECU 13 by the communication wires B11 to B14 can be considered to be function units as control targets of the zone-B ECU 13.

Function units as control targets of the light control unit are lamp bodies which are installed in the vehicle V, that is, lighting devices. For example, the control targets of the light control unit include headlights, direction indicators, fog lamps, brake lights, and reversing lights. The light control unit may control a lamp body, which illuminates an inside of a vehicle cabin of the vehicle V, as a control target. A function unit as a control target of the entry control unit is a wireless communication device which performs wireless communication with a key with a fob or another electronic key of the vehicle V. The entry control unit executes communication with the key of the vehicle V, thereby processes user access to the vehicle control system 1 from the outside of the vehicle, and realizes an action of so-called smart entry.

The communication wires B1 to B14 are formed from plural communication transmission paths which conform to various communication standards. Each of the communication wires B1 to B14 can be provided as a data transmission path which conforms to a different communication standard. That is, a specific configuration, a transmission band, and a communication standard of a cable that constitutes each of the communication wires B1 to B14 are arbitrarily selected. As communication standards which are applicable to the communication wires B1 to B14, for example, a controller area network (CAN), Ethernet®, a universal serial bus (USB), a local interconnect network (LIN), and a low-voltage differential signaling (LVDS) can be raised, but other standards may be used. The communication wires B1 to B6 are illustrated, in FIG. 1, as independent communication lines, but their specific configurations are not restricted, and for example, the communication wires B1 to B6 may be bus communication lines, which are connected with plural apparatuses, similarly to the communication wires B7 to B14.

FIG. 2 is an explanatory diagram of the manufacturing steps of the vehicle V. FIG. 2 is a diagram which illustrates an outline of the manufacturing steps of a four-wheeled automobile while dividing the outline based on principal contents but does not limit details of the manufacturing steps of devices of the vehicle. For example, a step indicated as one step in FIG. 2 may include plural detailed steps. The order of steps which is illustrated in FIG. 2 may appropriately be switched. As for manufacturing of the vehicle V, performance of a step which is not illustrated in FIG. 2 is not excluded.

The steps illustrated in FIG. 2 indicate steps of a main manufacturing line in a manufacturing factory of the vehicle V in a simplified manner, for example. In the manufacturing steps of the vehicle V, other steps in a so-called sub-line, which is different from the main manufacturing line, may be conducted, and although other steps may be conducted in another manufacturing factory or component factory, those steps are skipped in FIG. 2.

Step S1 denotes a vehicle body manufacturing step. In the vehicle body manufacturing step, various treatments such as pressing and welding are performed for row materials such as steel and aluminum materials or for structure components which are manufactured in another factory. In step S1, a vehicle body of the vehicle V, a so-called frame is manufactured.

Step S2 denotes a coating step. In the coating step, coating for the vehicle body manufactured in step S1 is performed.

Step S3 denotes an assembling step. In the assembling step, exterior components, interior components, driving system components, and other various components are mounted on the vehicle body for which coating is performed in the coating step. Following step S3, in step S4, an inspection step is performed. In the inspection step in step S4, a completion inspection of the vehicle V is performed.

In FIG. 2, the assembling step in step S3 is more specifically illustrated.

The assembling step includes a drive source installation step (step S31), a suspension mounting step (step S32), an accessory mounting step (step S33), an exterior mounting step (step S34), an interior component mounting step (step S35), an ECU wire-connection step (step S36), and a battery installation step (step S37).

In the drive source installation step (step S31), an internal combustion engine and/or a motor as drive sources of the vehicle V are mounted on the vehicle body. In manufacturing the vehicle V having the internal combustion engine, in step S31, components of an intake system and an exhaust system which are connected with the internal combustion engine are mounted. In manufacturing the vehicle V in which the motor is installed, in step S31, the traveling battery is mounted. In step S31, a transmission may be mounted together with the drive source. In step S31, a part or all of the ECUs 50 to be connected with the drive source are installed in the vehicle body. For example, in step S31, the ECUs 50 such as the FI control unit, the motor control unit, the BATT control unit, and the shift control unit may be installed in the vehicle body.

In the suspension mounting step (step S32), a suspension mechanism which is assembled in a sub-line is mounted on the vehicle body.

In the accessory mounting step (step S33), accessories of the vehicle V are mounted. The accessories include a compressor, a condenser, refrigerant piping, an alternator, a cooling water pump, a cooling water tank, cooling water piping, and an electric oil pump, which constitute an air-conditioning device, for example, and may include other components. In the accessory mounting step, installation, connection, and so forth of brake fluid piping may be performed.

In the suspension mounting step and the accessory mounting step, a part or all of the ECUs 50 to be connected with suspensions and accessories are installed in the vehicle body. In the suspension mounting step and the accessory mounting step, the ECU 50 such as the VSA control unit may be installed in the vehicle body.

In the exterior mounting step (step S34), exterior components such as bumpers, glass other than door glass, wipers, and lamp bodies are mounted. In the interior component mounting step (step S35), interior components of the vehicle V are mounted. The interior components include seats and a center console. In the interior component mounting step, a monitor or a touch panel of an automotive navigation system, a meter panel, and various cameras are mounted on the vehicle body.

In the exterior mounting step and the interior component mounting step, a part or all of the ECUs 50 to be connected with the exterior components and so forth are installed in the vehicle body. For example, in the exterior mounting step or the interior component mounting step, the ECUs 50 such as the light control unit and the entry control unit may be installed in the vehicle body.

In the ECU wire-connection step (step S36), the central ECU 2, the zone-A ECU 11, and the zone-B ECU 13 are installed in the vehicle body. In addition, in the ECU wire-connection step, the ECUs 50, which are not installed in steps S31 to S35, among the ECUs 50 which constitute the vehicle control system 1 are installed in the vehicle body. In the ECU wire-connection step, wire-connection of the communication wires B1 to B6 is made with the central ECU 2. For example, wire-connection of the communication wires B1 to B6 is made with one or plural connectors, and in the ECU wire-connection step, the connectors are connected with the central ECU 2. In addition, in the ECU wire-connection step, the communication wires B7 to B10 are connected with the zone-A ECU 11, and the communication wires B11 to B14 are connected with the zone-B ECU 13. By the ECU wire-connection step, the central ECU 2, the zone-A ECU 11, and the zone-B ECU 13 are mutually connected with the apparatuses as the control targets and the ECUs 50, and a state is established where control by the central ECU 2 is possible. That is, all of the ECUs 50 which have to be directly connected with the central ECU 2 and the ECUs 50 which have to be connected with the central ECU 2 via the zone-A ECU 11 and the zone-B ECU 13 are connected in the ECU wire-connection step. In the ECU wire-connection step, in a state where the vehicle control system 1 is not energized, a connection test may be performed which is for checking electrical connection states between the central ECU 2 and the various ECUs 50 which are connected with the central ECU 2.

By a wire-connection step of the ECU wire-connection step, the central ECU 2, the zone-A ECU 11, and the zone-B ECU 13 are mutually connected with the apparatuses as the control targets and the ECUs 50, and a state is established where control by the central ECU 2 is possible.

The ECU wire-connection step in step S36 corresponds to one example of a wire-connection step in the present disclosure. Because the central ECU 2 and the ECUs 50 are installed in steps S31 to S36, those steps correspond to one example of a providing step in the present disclosure.

After the ECU wire-connection step (step S36), in the battery installation step (step S37), the starting battery is installed in the vehicle V. Wire-connection of the starting battery is made with the vehicle control system 1 in the ECU wire-connection step. As described above, the starting battery supplies power to the vehicle control system 1. Power of the starting battery is supplied as a power source for at least the central ECU 2, the zone-A ECU 11, and the zone-B ECU 13. After step S37, the vehicle control system 1 is started by power supplied by the starting battery and is set to a state where each unit of the vehicle control system 1 is capable of executing control. Specifically, after the step S37, the diagnostic device 300 is connected with the DLC 19, and the diagnostic device 300 is thereby capable of executing communication with the central ECU 2.

After the battery installation step (step S37), a fluid injection step (step S38) and an opening-closing body mounting step (step S39) are performed for the vehicle V. In step S38, various liquids used for the vehicle V are injected. For example, in step S38, cooling water is injected into a water-cooling mechanism which cools the drive source of the vehicle V. A brake fluid is injected into brake piping of the vehicle V. In the fluid injection step, other liquids may be injected.

In step S38, opening-closing bodies of the vehicle V are mounted. As the opening-closing bodies, for example, doors DR and a rear gate RG are raised. In step S38, the assembling step (step S3) is completed, and the inspection step in step S4 is executed.

Step S37 corresponds to one example of an injection step in the present disclosure, and step S38 corresponds to one example of an opening-closing body mounting step in the present disclosure.

In the manufacturing steps of the vehicle V of the present disclosure, in parallel with steps S38 and S39, a program writing step (step S40) is executed. Step S40 corresponds to one example of a writing step in the present disclosure.

The program writing step is started after the battery installation step (step S37) and before the fluid injection step (step S38) or after the fluid injection step. The program writing step may be finished before the opening-closing body mounting step (step S39) is started or may be continued to be executed after the opening-closing body mounting step (step S39) is started.

In the program writing step, the central ECU 2 writes programs to the ECUs 50 included in the vehicle control system 1. Targets of the program writing step include the ECUs 50 which are connected with the central ECU 2 by the communication wires B4 to B6, the ECUs 50 which are connected with the zone-A ECU 11 by the communication wires B7 to B10, and the ECUs 50 which are connected with the zone-B ECU 13 by the communication wires B11 to B14. In the program writing step, programs may be written to the zone-A ECU 2 and the zone-B ECU 13.

FIG. 3 is a block diagram illustrating a principal component configuration of the vehicle control system 1.

For explaining writing of programs in the vehicle control system 1, a configuration of a part of the ECUs 50 which constitute the vehicle control system 1 is illustrated in FIG. 3.

As illustrated in FIG. 3, the central ECU 2 has a processing unit 21 and a communication device 23. The communication device 23 executes communication via the communication wires B1 to B6 in accordance with control by the processing unit 21.

The processing unit 21 includes a processor 210 and a memory 220.

The processor 210 is formed from a central processing unit (CPU), a micro-controller unit (MCU), or a micro-processor unit (MPU), for example. The memory 220 is a rewritable non-volatile storage device and stores programs which are executed by the processor 210 and data which are processed by the processor 210. The memory 220 is formed from a semiconductor storage device such as a flash read-only memory (ROM) or a solid state disk (SSD) or a magnetic storage device, for example. The memory 220 may include a random access memory (RAM) which forms a work area for temporarily storing programs and data. The processing unit 21 may be formed from an integrated circuit (IC) which integrally includes the processor 210 and the memory 220. The central ECU 2 may be an integrated circuit in which the processing unit 21 and the communication device 23 are united. The central ECU 2 may be configured to include the communication device 23, the processor 210, and the memory 220 as pieces of independent hardware.

The memory 220 stores a control program 221, control data 222, writing data 230, and result data 236.

The control program 221 is a program which is executed by the processor 210. The control data 222 are data which are referred to in a case where the processor 210 executes the control program 221. The processor 210 executes the control program 221 based on the control data 222 and thereby executes management and control of delivery and acceptance of data in the vehicle control system 1 and communication by the DLC 19. The processor 210 executes the control program 221 and thereby controls the TCU, the meter panel, and so forth. The processor 210 executes the control program 221 and thereby controls the OTA management of the ECUs 50 which constitute the vehicle control system 1. The memory 220 corresponds to one example of a master storage unit in the present disclosure.

A configuration of the ECU 50 as a writing target will be described. FIG. 3 illustrates the zone-A ECU 11, the zone-B ECU 13, and ECUs 50C, 50D, 50E, 50F, 50G, and 50H as examples of the ECUs 50 as the writing targets of the central ECU 2. The ECUs 50C to 50H are examples of the ECUs 50. Specifically, those are the FI control unit, the motor control unit, the BATT control unit, the shift control unit, the VSA control unit, and so forth. Although FIG. 3 illustrates a configuration of a part of the vehicle control system 1, a configuration may be made such that the central ECU 2 is capable of writing programs to all of the ECUs 50 included in the vehicle control system 1.

The zone-A ECU 11 includes a processor 91A and a memory 93A. The zone-B ECU 13 includes a processor 91B and a memory 93B. Similarly, the ECU 50C includes a processor 91C and a memory 93C, the ECU 50D includes a processor 91D and a memory 93D, and the ECU 50E includes a processor 91E and a memory 93E. The ECU 50F includes a processor 91F and a memory 93F, the ECU 50G includes a processor 91G and a memory 93G, and the ECU 50H includes a processor 91H and a memory 93H. In the following, in a case where the ECUs 50C to 50H are not distinguished, those are denoted as ECU 50. In a case where the processors 91A to 91H are not distinguished, those are denoted as processor 91. In a case where the memories 93A to 93H are not distinguished, those are denoted as memory 93. The memory 93 corresponds to one example of a program storage unit in the present disclosure.

The processor 91 is formed from a CPU, an MCU, or an MPU, for example. The memory 93 is a rewritable non-volatile storage device and stores programs which are executed by the processor 91 and data which are processed by the processor 91. The memory 93 is formed from a semiconductor storage device such as a flash ROM or an SSD or a magnetic storage device, for example. The memory 93 may include a RAM which forms a work area for temporarily storing programs and data. Each of the ECUs 50 may be formed from an integrated circuit which integrally includes the processor 91 and the memory 93.

The processor 91 executes a basic control program stored in the memory 93 and thereby executes communication with the central ECU 2. The processor 91 executes a control program stored in the memory 93 and thereby controls a function unit as a control target.

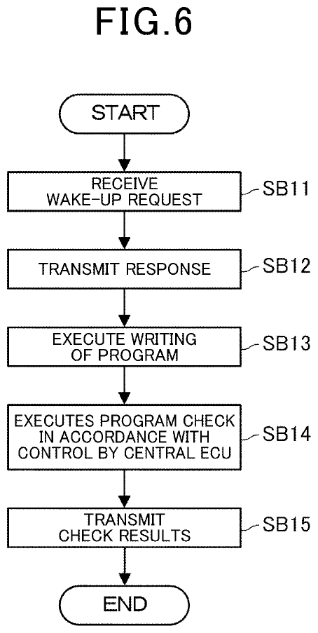

Before the program is written by the central ECU 2 in the program writing step, the memory 93 does not store the program for controlling the function unit as the control target by the processor 91. In this state, the memory 93 stores a program for executing a basic action by the processor 91. For example, before a writing process, the memory 93 stores a program, by which the processor 91 executes communication with the central ECU 2 and executes a process illustrated in FIG. 6. For example, before the program writing step, the memory 93 may already store the program for controlling the function unit as the control target by the processor 91. In this case, in the program writing step, a part of the program stored in the memory 93 is overwritten and updated.

The zone-A ECU 11 may include a communication device which executes communication by the communication wires B1, B7 to B10 in addition to the processor 91A and the memory 93A. The zone-B ECU 13 may include a communication device which executes communication by the communication wires B2, B11 to B14 in addition to the processor 91B and the memory 93B. Each of the ECUs 50 other than the zone-A ECU 11 and the zone-B ECU 13 may be configured to include a communication device which is not illustrated and performs data communication with the zone-A ECU 11 or the zone-B ECU 13 and performs transmission and reception of a signal to and from the function unit as the control target.

The writing data 230 which are stored in the memory 220 by the central ECU 2 are data for writing programs to the ECUs 50 of the vehicle control system 1 by the processor 210. The writing data 230 include a writing processing program 231, a writing setting table 232, and an ECU program 233.

The writing processing program 231 is a program which is executed by the processor 210. The processor 210 executes the writing processing program 231 and thereby executes writing of a program to the ECU 50 in the manufacturing steps of the vehicle V.

The writing setting table 232 includes information about the ECUs 50 as targets to which programs are written by the central ECU 2. The writing setting table 232 associates the ECU 50 as the target of the writing process to be executed by the central ECU 2 with the ECU program 233 to be written to the memory 93 provided to the ECU 50. The writing setting table 232 corresponds to one example of association data.

The writing setting table 232 includes a model number of the ECU 50 as information about the ECU 50 as the target to which the program is written by the central ECU 2. The writing setting table 232 may include information which indicates a specification and a destination of the ECU 50 in addition to the model number of the ECU 50. The writing setting table 232 may include a manufacturing number (serial number) specific to the ECU 50 or a manufacturing lot number of the ECU 50 together with the model number of the ECU 50.

The writing data 230 include plural ECU programs 233 which correspond to the respective ECUs 50 as writing targets. For example, an ECU program 233A is a program which corresponds to the zone-A ECU 11 and is written to the memory 93A. An ECU program 233B is a program which corresponds to the zone-B ECU 13 and is written to the memory 93B. An ECU program 233C is a program which corresponds to the FI control unit and is written to the memory 93C. Information which associates the ECU programs 233A, 233B, and 233C with the zone-A ECU 11, the zone-B ECU 13, and the ECU 50 is included in the writing setting table 232.

The number of ECU programs 233 included in the writing data 230 is not restricted. The writing data 230 preferably include the ECU programs 233 which correspond to all of the ECUs 50 of the vehicle control system 1 of the vehicle V in which the central ECU 2 is installed.

The ECU program 233 may be the same as a program which is written to the memory 93. The ECU program 233 may be stored in the memory 220 in a compressed state and be written to the memory 93 while being expanded by the processor 210.

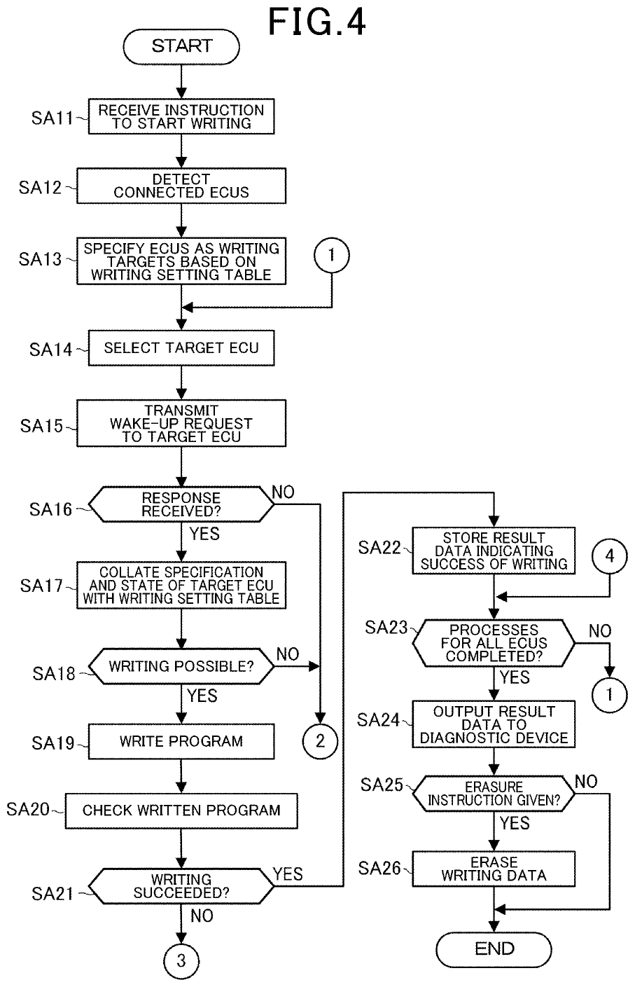

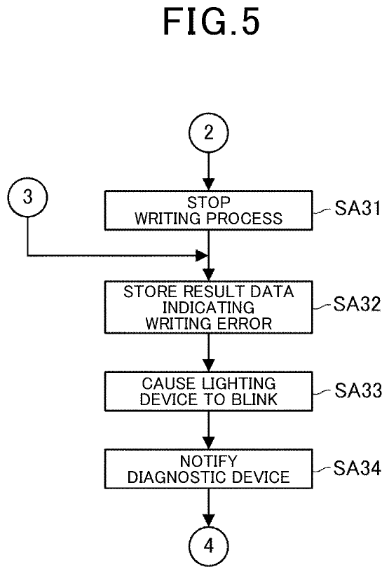

FIG. 4, FIG. 5, and FIG. 6 are flowcharts illustrating actions of the vehicle control system 1. FIG. 4 and FIG. 5 illustrate actions of the central ECU 2, and FIG. 6 illustrates actions of the ECU as the writing target.

The action illustrated in FIG. 4 is executed in a state where the diagnostic device 300 is connected with the DLC 19. Specifically, the worker operates the diagnostic device 300, and the diagnostic device 300 thereby transmits a command for instructing a start of the writing process to the vehicle control system 1. This command serves as a trigger for a start of the writing process.

The processor 210 receives the command from the diagnostic device 300 (step SA11) and detects the ECUs which are connected with the central ECU 2 (step SA12). In step SA12, the processor 210 detects the ECUs which are connected with the central ECU 2 by the communication wires B1 to B6 and further the ECUs which are connected with the central ECU 2 via the zone-A ECU 11 and the zone-B ECU 13.

The processor 210 specifies the ECUs as targets of the writing process based on the writing setting table 232 (step SA13). The processor 210 can execute writing of programs to plural ECUs by using the writing data 230. In step SA13, among the ECUs detected in step SA12, all of the ECUs are specified which can be the targets of the writing process.

The processor 210 selects one or plural target ECUs from the ECUs specified in step SA13 (step SA14). In a case where plural target ECUs are selected, the processor 210 may execute actions indicated by steps SA15 to SA26 and SA31 to SA34, which will be described in the following, for one target ECU and may execute those processes in parallel or sequentially for the number of target ECUs.

The processor 210 transmits the wake-up request to the target ECU (step SA15). The wake-up request is a signal to request the target ECU in the standby state to start. The target ECU is capable of receiving the wake-up request in a state where the power source is supplied by the starting battery. In a normal action, the target ECU transmits a response to the wake-up request to the central ECU 2 as described later by referring to FIG. 6.

The processor 210 determines whether or not the response to the wake-up request is received from the target ECU (step SA16). In a case where the response is not received in a predetermined time period (NO in step SA16), the processor 210 proceeds to step SA31 which will be described later.

In a case where the response is received from the target ECU (YES in step SA16), the processor 210 collates at least either one of a specification and a state of the target ECU with the writing setting table 232 (step SA17). The specification of the target ECU indicates a model number of the target ECU, a destination of the target ECU, and a specification adapted to attached components of the vehicle V. The state of the target ECU means presence or absence of a program which is already stored in the memory 93 of the target ECU, a version of a program, and so forth. The writing setting table 232 includes information which designates the specification and/or the state of the target ECU, to which the ECU program 233 can be written, for each of the ECUs which can be the target ECUs. The processor 210 causes the target ECU to transmit information which indicates the specification and the state, for example, and thereby performs collation in step SA17.

The processor 210 determines whether or not writing of a program to the target ECU is possible as a result of the collation in step SA17 (step SA18). In a case where it is determined that writing is not possible (NO in step SA18), the processor 210 proceeds to step SA31 which will be described later.

In a case where it is determined that writing is possible (YES in step SA18), the processor 210 writes the program to the memory 93 provided to the target ECU (step SA19). The program which is written by the processor 210 in step SA19 is the ECU program 233 which is associated with the target ECU by the writing setting table 232.

The processor 210 checks the program which is written to the memory 93 by a process in step SA19 (step SA20). In step SA20, the processor 210 may instruct the target ECU to check the program, and the target ECU may thereby execute a check. The processor 210 may read out the program written to the memory 93 and thereby execute the check.

The processor 210 determines whether or not writing of the program is normally completed based on results of the check in step SA20 (step SA21).

In a case where it is determined that writing of the program is not normally completed (NO in step SA21), the processor 210 proceeds to step SA32 which will be described later.

In a case where it is determined that writing of the program is normally completed (YES in step SA21), the processor 210 generates result data 235 which indicate success of writing and stores the result data 235 in the memory 220 (step SA22). The result data 235 are data including information which indicates the target ECU and information which indicates that writing has succeeded.

The processor 210 determines whether or not processes for all of the ECUs specified in step SA13 are completed (step SA23). In other words, the processor 210 determines whether or not all of the ECUs are selected as the target ECUs in step SA14. In a case where it is determined that the processes for all of the ECUs are completed (YES in step SA23), the processor 210 outputs the result data 235 stored in the memory 220 to the diagnostic device 300 via the DLC 19 (step SA24).

The processor 210 determines whether or not an instruction to erase the writing data 230 is input from the diagnostic device 300 (step SA25). In a case where the instruction for erasure is input (YES in step SA25), the processor 210 erases the writing data 230 from the memory 220 (step SA26) and finishes the current process. In a case where the instruction for erasure is not input (NO in step SA25), the processor 210 skips step SA26 and finishes the current process.

In a case where it is determined that the processes for all of the target ECUs are not completed (NO in step SA23), the processor 210 returns to step SA14 and selects the next target ECU.

Meanwhile, in step SA31, the processor 210 stops the process for the target ECU which has been selected (step SA31). Next, in step SA32, the processor 210 generates the result data 235 which indicate a writing error and stores the result data 235 in the memory 220 (step SA32). The result data 235 which are generated in step SA32 include information that indicates the target ECU which has been selected and information that indicates that writing has not succeeded. The result data 235 correspond to one example of writing error information.

The processor 210 further causes the lamp body installed in the vehicle V to blink (step SA33). In step SA33, for example, the processor 210 controls the light control unit which controls the lamp body and thereby causes the direction indicator of the vehicle V to blink. Accordingly, an occurrence of an error to writing of the program can be notified to the worker who is present along a manufacturing line of the vehicle V. In addition, the processor 210 notifies the occurrence of the error to writing of the program to the diagnostic device 300 via the DLC 19 (step SA34) and proceeds to step SA23. In step SA34, the processor 210 may transmit a signal, which indicates the occurrence of the error to writing of the program, to the diagnostic device 300. Alternatively, the processor 210 may transmit the result data 235 to the diagnostic device 300. In this case, an advantage can be obtained where the diagnostic device 300 displays contents of the result data 235 and the worker can thereby be informed of contents of the error in detail.

As illustrated in FIG. 6, in the writing process, the processor 91 of the target ECU receives the wake-up request from the central ECU 2 (step SB11). The target ECU can receive the wake-up request in a state where the power source is supplied by the starting battery. The processor 91 may execute initialization of each unit including the memory 93, transition among the action modes for writing the program, and so forth.

The processor 91 transmits the response to the wake-up request to the central ECU 2 (step SB12). Subsequently, the processor 91 executes writing of the program to the memory 93 in accordance with control by the central ECU 2 (step SB13). After writing of the program, the processor 91 executes a check of the program, which is written to the memory 93, in accordance with control by the central ECU 2 (step SB14), transmits check results to the central ECU 2 (step SB15), and finishes the current process. Note that as described above, in a case where the central ECU 2 executes the check of the program which is written to the memory 93, step SB15 is skipped.

The actions illustrated in FIG. 4 to FIG. 6 are executed for at least a part of the ECUs of the vehicle control system 1 installed in the vehicle V, and work for checking specifications and states of programs of the ECUs in the manufacturing steps of the vehicle V can thereby be reduced. In addition, when programs are written to a larger number of ECUs by the actions illustrated in FIG. 4 to FIG. 6, much higher efficiency of the manufacturing steps of the vehicle V can be intended.

The above embodiment represents one specific example to which the present invention is applied but does not limit forms to which the invention is applied.

In the above embodiment, a configuration is made such that the processes illustrated in FIG. 4 to FIG. 6 are executed in a state where no program is written to the memory 93, but the central ECU 2 may overwrite a program to the memory 93, to which a program has been written, in step SA19. In this case, because the program of each of the ECUs of the vehicle control system 1 is newest by the program writing step, work for in advance checking the version of the program can be omitted.

In the above embodiment, a description is made about an example where the memory 220 in a state where that in advance stores the writing data 230 is installed in the vehicle V, but this is one example. For example, after the central ECU 2 is installed in the vehicle V, in the ECU wire-connection step (step S36) or the battery installation step (step S37), or before or after those, the writing data 230 may be transmitted from the diagnostic device 300 to the central ECU 2, and the writing data 230 may thereby be stored in the central ECU 2. In this case, because it is sufficient that data or a program to be stored in the memory 220 by the central ECU 2 is prepared before the program writing step (step S40), a further improvement in efficiency in the manufacturing steps of the vehicle V can be intended.

The configuration of the vehicle control system 1 which is described in the above embodiment is one example, and types of the ECUs, the number of ECUs, and configurations of devices as control targets of the ECUs included in the vehicle control system 1 can variously be changed.

Step units illustrated in FIG. 2, FIG. 4 to FIG. 6 result from division which corresponds to main process contents for easy understanding of the manufacturing steps of the vehicle V and the actions in the vehicle control system 1 and are not limited by manners of division of the process units or names. Division into more step units may be made in accordance with process contents. Division may be made such that one step unit includes more processes. The order of steps may appropriately be switched.

The above embodiment supports the following configurations.

(Configuration 1) A vehicle manufacturing method including: a placement step of placing, in a vehicle, a vehicle control unit and a master control unit, the vehicle control unit including a non-volatile program storage unit and controlling a function unit installed in the vehicle by executing a program stored in the program storage unit; a wire-connection step of connecting the master control unit with a plurality of the vehicle control units by a communication wire; and a writing step of executing a writing process of writing the program to the program storage unit for the vehicle control unit which is connected with the master control unit by the communication wire by the master control unit.

In the vehicle manufacturing method of the configuration 1, it is possible to write the program to the vehicle control unit by the master control unit in the manufacturing steps of the vehicle. Accordingly, because the program does not have to be already written in a state where the vehicle control unit is installed in the vehicle, it is possible to skip or simplify work for writing the program to the individual vehicle control unit, a step of checking a specification or a state of the individual vehicle control unit, and a step of writing the program to each vehicle control unit. Consequently, it is possible to shorten a production time period in a manufacturing factory of the vehicle while an improvement in fuel efficiency of the vehicle and installation of driving assistance technologies and preventive safety technologies in the vehicle are handled, and reduction in an emission amount of carbon dioxide in the manufacturing steps of the vehicle can be realized.

(Configuration 2) The vehicle manufacturing method which is described in the configuration 1, in which in the placement step, the master control unit is placed while the master control unit stores writing data for writing the program to program storage units of the vehicle control units.

In the vehicle manufacturing method of the configuration 2, in a state where the vehicle control unit and the master control unit are installed in the vehicle, writing of the program to the individual vehicle control unit can be executed. Thus, work for writing the program before the vehicle control unit is installed in the vehicle or work for checking the program can be simplified or skipped. Consequently, the production time period in the manufacturing factory of the vehicle can further be shortened.

(Configuration 3) The vehicle manufacturing method which is described in the configuration 1 or the configuration 2, including a battery connection step of connecting a starting battery of the vehicle with the vehicle control unit and the master control unit after the wire-connection step, in which the writing step is executed after the battery connection step.

In the vehicle manufacturing method of the configuration 3, in a state where wire-connection is made between the master control unit and the vehicle control unit and the power source is supplied by the starting battery, the program is written by the master control unit. Accordingly, it is possible to certainly write the program in a state where a stable power source can be supplied from the starting battery, and reliability in the manufacturing steps of the vehicle can be maintained.

(Configuration 4) The vehicle manufacturing method which is described in any one of the configuration 1 to the configuration 3, in which after the writing step is started, at least either one of an injection step of injecting cooling water into a water-cooling mechanism of the vehicle and an opening-closing body mounting step of mounting an opening-closing body of the vehicle is executed.

In the vehicle manufacturing method of the configuration 4, the injection step or the opening-closing body mounting step is executed in parallel with the writing step, and the production time period in the manufacturing factory of the vehicle can thereby further be shortened. Because in the injection step or the opening-closing body mounting step, the possibility is very low that a large vibration or impact is applied to the master control unit or the vehicle control unit, an improvement in manufacturing efficiency can be intended without impairing reliability of the writing step.

(Configuration 5) A vehicle control system including: a vehicle control unit which includes a non-volatile program storage unit and controls a function unit installed in a vehicle by executing a program stored in the program storage unit; and a master control unit which is connected with the vehicle control unit, in which the master control unit includes a non-volatile master storage unit, stores writing data for writing the program to the program storage unit in the master storage unit, is capable of executing a writing process of writing the program to the program storage unit provided to the vehicle control unit based on the writing data, transmits a wake-up request to the vehicle control unit, and subsequently performs the writing process for the vehicle control unit, which is a transmission destination of the wake-up request, as a target.

In the vehicle control system of the configuration 5, because the program can be written to the vehicle control unit by the master control unit, the vehicle control unit in a state where the program is not installed can be installed in the vehicle and can be connected with the master control unit. Accordingly, in the manufacturing steps of the vehicle, it is possible to install the vehicle control unit in a state where the program is not written in the vehicle and to write the program by the master control unit. Thus, it is possible to skip or simplify the step of checking the specification or the state of the program of the vehicle control unit and the step of writing the program to each vehicle control unit. Consequently, it is possible to shorten a production time period in a manufacturing factory of the vehicle while an improvement in fuel efficiency of the vehicle and installation of driving assistance technologies and preventive safety technologies in the vehicle are handled, and reduction in an emission amount of carbon dioxide in the manufacturing steps of the vehicle can be realized.

(Configuration 6) The vehicle control system which is described in the configuration 5, in which the writing data include the program which is written to the program storage unit and association data which associate the program with the vehicle control unit, and the master control unit performs the writing process for the vehicle control unit in accordance with the association data.

In the vehicle control system of the configuration 6, the program which is written to the vehicle control unit by the master control unit is clearly specified, and the master control unit can accurately write programs to plural vehicle control units. Thus, a program which is compatible with the vehicle control unit can certainly be written to the vehicle control unit by the master control unit. Accordingly, reliability in the manufacturing steps of the vehicle can more certainly be maintained.

(Configuration 7) The vehicle control system which is described in the configuration 5 or the configuration 6, in which the master control unit is capable of being connected with a plurality of the vehicle control units, and the master control unit performs the writing process after all of the vehicle control units to be connected with the master control unit are connected with the master control unit and all of the vehicle control units are connected with function units.

In the vehicle control system of the configuration 7, after the vehicle control unit as a target to which the program is written is installed in the vehicle and is connected with the master control unit, writing of the program is performed. Accordingly, assembly of the vehicle control unit during writing of the program can be avoided, a situation where writing of the program fails due to an impact or vibration to the vehicle control unit can be prevented, and reliability in the manufacturing steps of the vehicle can more certainly be maintained.

(Configuration 8) The vehicle control system which is described in any one of the configuration 5 to the configuration 7, including a connection unit that connects an external device which is present on an outside of the vehicle control system with the master control unit, in which in a case where an instruction is input from the external device, the master control unit transmits the wake-up request to the vehicle control unit.

In the vehicle control system of the configuration 8, an instruction is input to the master control unit by the external device, and the master control unit thereby starts writing of the program to the vehicle control unit. Accordingly, a timing of writing of the program by the master control unit can properly be managed. Because it is sufficient that the external device only inputs the instruction to the mater control unit, an advantage is present where a workload in the manufacturing steps of the vehicle is small.

(Configuration 9) The vehicle control system which is described in the configuration 8, in which the master control unit notifies that the writing process is in progress to the external device before or during execution of the writing process for the vehicle control unit, and at least either one of the master control unit which is executing the writing process and the vehicle control unit which is executing the writing process makes transition to a state where the instruction from the external device is not accepted.

In the vehicle control system of the configuration 9, a situation can be avoided where a disturbance occurs to writing of the program due to access which is made to the vehicle control unit during writing of the program.

(Configuration 10) The vehicle control system which is described in the configuration 8 or the configuration 9, in which in a case where the writing process does not succeed, the master control unit notifies writing error information to the external device, the writing error information including information that indicates the vehicle control unit as a target of the writing process which does not succeed.

In the vehicle control system of the configuration 10, the fact that the writing process of the program has not succeeded and information which specifies the vehicle control unit for which the writing process has not succeeded are notified to the external device. Thus, a worker who operates the external device can in detail be informed of a state of the writing process of the program.

(Configuration 11) The vehicle control system which is described in any one of the configuration 5 to the configuration 9, in which in a case where the writing process does not succeed, the master control unit stores writing error information in the master storage unit, the writing error information including information that indicates the vehicle control unit as a target of the writing process which does not succeed.

In the vehicle control system of the configuration 11, in a case where the writing process of the program has not succeeded, detailed information is stored in the master storage unit. Thus, execution of writing of the program or the like can again be executed by control by the master control unit.

(Configuration 12) The vehicle control system which is described in any one of the configuration 5 to the configuration 11, in which in a case where the writing process does not succeed, the master control unit causes a lamp body to be lit or to blink by the vehicle control unit which controls the lamp body of the vehicle.

In the vehicle control system of the configuration 12, the fact that the writing process of the program has not succeeded can be informed to a worker in the manufacturing steps of the vehicle.

### REFERENCE SIGNS LIST

1 vehicle control system
2 central ECU (master control unit)
11 zone-A ECU (vehicle control unit)
13 zone-B ECU (vehicle control unit)
19 DLC (connection unit)
21 processing unit
23 communication device
50 ECU (vehicle control unit)
91, 91A to 91H processor
93, 93A to 93H memory (program storage unit)
210 processor
220 memory (master storage unit)
221 control program
222 control data
230 writing data
231 writing processing program
232 writing setting table (association data)
233, 233A to 233C ECU program
235 result data (writing error information)
300 diagnostic device (external device)
B1 to B14 communication wire
CB communication cable
DR door (opening-closing body)
RG rear gate (opening-closing body)
V vehicle

What is claimed is:

1. A vehicle manufacturing method comprising:
a placement step of placing, in a vehicle, a vehicle control unit and a master control unit, the vehicle control unit including a non-volatile program storage unit and controlling a function unit installed in the vehicle by executing a program stored in the program storage unit;
a wire-connection step of connecting the master control unit with a plurality of the vehicle control units by a communication wire; and
a writing step of executing a writing process of writing the program to the program storage unit for the vehicle control unit which is connected with the master control unit by the communication wire by the master control unit.

2. The vehicle manufacturing method according to claim 1, wherein
in the placement step, the master control unit is placed while the master control unit stores writing data for writing the program to program storage units of the vehicle control units.

3. The vehicle manufacturing method according to claim 1, comprising:
a battery connection step of connecting a starting battery of the vehicle with the vehicle control unit and the master control unit after the wire-connection step, wherein
the writing step is executed after the battery connection step.

4. The vehicle manufacturing method according to claim 1, wherein
after the writing step is started, at least either one of an injection step of injecting cooling water into a water-cooling mechanism of the vehicle and an opening-closing body mounting step of mounting an opening-closing body of the vehicle is executed.

5. A vehicle control system comprising:
a vehicle control unit which includes a non-volatile program storage unit and controls a function unit installed in a vehicle by executing a program stored in the program storage unit; and
a master control unit which is connected with the vehicle control unit, wherein
the master control unit
includes a non-volatile master storage unit, stores writing data for writing the program to the program storage unit in the master storage unit,
is capable of executing a writing process of writing the program to the program storage unit provided to the vehicle control unit based on the writing data,
transmits a wake-up request to the vehicle control unit, and subsequently performs the writing process for the vehicle control unit, which is a transmission destination of the wake-up request, as a target.

6. The vehicle control system according to claim 5, wherein
the writing data include the program which is written to the program storage unit and association data which associate the program with the vehicle control unit, and
the master control unit performs the writing process for the vehicle control unit in accordance with the association data.

7. The vehicle control system according to claim 5, wherein
the master control unit is capable of being connected with a plurality of the vehicle control units, and
the master control unit performs the writing process after all of the vehicle control units to be connected with the master control unit are connected with the master control unit and all of the vehicle control units are connected with function units.

8. The vehicle control system according to claim 5, comprising
a connection unit that connects an external device which is present on an outside of the vehicle control system with the master control unit, wherein
in a case where an instruction is input from the external device, the master control unit transmits the wake-up request to the vehicle control unit.

9. The vehicle control system according to claim 8, wherein
the master control unit notifies that the writing process is in progress to the external device before or during execution of the writing process for the vehicle control unit, and
at least either one of the master control unit which is executing the writing process and the vehicle control unit which is executing the writing process makes transition to a state where the instruction from the external device is not accepted.

10. The vehicle control system according to claim 8, wherein
in a case where the writing process does not succeed, the master control unit notifies writing error information to the external device, the writing error information including information that indicates the vehicle control unit as a target of the writing process which does not succeed.

11. The vehicle control system according to claim 5, wherein
in a case where the writing process does not succeed, the master control unit stores writing error information in the master storage unit, the writing error information including information that indicates the vehicle control unit as a target of the writing process which does not succeed.

12. The vehicle control system according to claim 5, wherein
in a case where the writing process does not succeed, the master control unit causes a lamp body to be lit or to blink by the vehicle control unit which controls the lamp body of the vehicle.
